(19) United States
(12) Patent Application Publication
(10) Pub. No.: US 2006/0170670 A1
(43) Pub. Date: Aug. 3, 2006

(54) Interactive electronic dispaly, methods and apparatus for targeted propagation of sign content, systems for capturing and sending photographs and video, as a means of integrated customer service, information capture and marketing

(76) Inventor: Joel Steven Burke, Vancouver (CA)

Correspondence Address: Joel Burke, 112 - 1450 Pennyfarthing Dr., Vancouver, BC, V6J 4X8, CA

(21) Appl. No.: 11/270,561

(22) Filed: Nov. 10, 2005

Related U.S. Application Data
(60) Provisional application No. 60/626,446, filed on Nov. 10, 2004.

(51) Int. Cl. G06T 1/00

(52) U.S. Cl. 345/418

(57) ABSTRACT

The present invention provides an apparatus and methods for a photo-interactive consumer service and marketing system. The system apparatus consists of a network of terminals back-ended by a central server. The onsite terminal consists of an interactive electronic display featuring a lighting display compartment and a electronics compartment for user user interactivity, including audio video input and credit card reader. The display is electronically connected to a server and online payment company. A user may send a message comprising an electronic postcard or a video message from the display to one or more recipients. The message is accompanied by promotional material selected by the host of the display.

### RELATED APPLICATIONS

This application claims the benefit of U.S. provisional application Ser. No. 60/626446 filed Nov. 10, 2004, hereby incorporated by reference in its entirety.

### FIELD OF THE INVENTION

The invention relates to electronic displays, and systems incorporating such displays. Some aspects of the invention pertain to interactive electronic “talking” displays incorporated into light boxes. Some aspects of the invention pertain to hardware and software for interactive electronic displays, systems for enabling targeted propagation of content, and online server systems.

### BACKGROUND OF THE INVENTION

Business operators are always looking for new ways in which to promote their business, either to potential customers onsite or offsite. Typically onsite signage is a passive attempt to deliver a message to draw customers in. Businesses have little in the way of obtaining customers' contact info, product/service feedback, and getting their customer participation beyond their physical onsite patronage.

### SUMMARY OF THE INVENTION

The inventor has designed a system involving an interactive sign plus other support features by which all of the above is addressed and enabled, while providing operators with enhanced promotional and marketing opportunities, through the use of a custom application of an electronic postcard program, conveying user photos, video and audio, as well as recipient data.

The inventor has identified a need and applications for interactive signage which allow both 1-way and 2-way interactive communication between the onsite user of such a display and the business (or location) to an offsite individual anywhere in the world.

Herein outlined are inventive methods and apparatus which may be applied to provide consumer activated automated vending and marketing systems functioning for a business either onsite or offsite. As well, methods and apparatus outlined herein may be also used to provide complete integrated e-photo/video vending customer service systems. Such systems may serve as platforms for a variety of different customer services, and may also be “integrated” with promotions which originate within or outside the business.

Systems according to currently preferred embodiments of the invention include interactive signs which may be placed at locations where customers may be inclined to interact with the signs. Some example locations are resorts, tourist attractions, airports and other transportation facilities, hotels, restaurants, shopping malls, movie theaters, concert halls, and the like. The signs may comprise both backlit static display portions and electronic display portions. An interactive sign according to certain embodiments of the invention may comprise a system for both onsite customer service. The system may implement a business model for propagating promotional information homogeneously to an offsite recipient with whom the sender is familiar. The onsite customer is able to respond to the themed content of the backlit poster sign by interacting with a like-themed software, supported by integrated electronic component(s) in the sign. This software may be connected to a “back-end” supporting central server which may then issue a webpage duplicate of the “themed” sign content to the offsite recipient. The recipient may interact with the themed webpage sign-“duplicate” with various options available to them.

Other aspects of the invention pertain to a unique mode of distribution for photos, video and audio to recipients over the internet. Other aspects of the invention relate to the ability to capture both onsite and offsite user information plus customer feedback. Other aspects of the invention provide systems for enabling a business to send out advertising and/or marketing information to recipients of electronic postcards, video greetings and user reviews.

One aspect of the invention provides an interactive electronic display having a lighting compartment and an electronics compartment covered by a panel constructed from a single sheet of material, wherein the panel includes a keyboard formed in the sheet of material with which a user may interact with the display by way of the keyboard. Some aspects of the invention provide systems for enabling a business to send out advertising and/or marketing information to recipients of electronic postcards, video greetings and user reviews. Some aspects of the invention provide systems for businesses to send out personalized merchandise to recipients selected by the user.

Further aspects of the invention and features of specific embodiments of the invention are described below.

### A BRIEF DESCRIPTION OF THE DRAWINGS

In drawings which illustrate non-limiting embodiments of the invention:

FIG. 1 is an isometric view of an interactive electronic display according to one aspect of the invention;

FIG. 2 shows the display of FIG. 1 with the front panel in a partially open position;

FIG. 2A is a view taken along line A-A of FIG. 2;

FIG. 3 shows the display of FIG. 1 with the front panel removed;

FIG. 4 shows a display according to another aspect of the invention with the front panel removed;

FIG. 5 schematically illustrates a system according to one aspect of the invention;

FIGS. 6.1 and 6.2 are a flowchart illustrating a method carried out on a kiosk according to one aspect of the invention;

FIG. 7 is a flowchart illustrating a method carried out on an interactive electronic display according to one aspect of the invention;

FIG. 8 schematically illustrates a marketing system according to one aspect of the invention;

FIG. 9 is a photograph of the keyboard of the display of FIG. 1;

FIG. 10 is a photograph showing the internal components of the display of FIG. 1;

FIG. 11 shows an example of how content may be propagated according to some aspects of the invention;

FIG. 12 shows an example of contents of the display according to some aspects of the invention;

FIGS. 13 shows an example of a content distribution according to some aspects of the invention;

FIG. 14 shows example components of an interactive sign system according to some aspects of the invention;

FIG. 15 shows an example of a content propagation system according to some aspects of the invention;

FIG. 16 shows an example of a two-way customer support interaction according to some aspects of the invention;

FIG. 17 shows an example of a video capture and distribution system according to some aspects of the invention;

FIG. 18 shows examples of some interactions between systems according to some aspects of the invention;

FIG. 19 shows an example of a video opinion feedback system according to some aspects of the invention;

FIG. 20 shows an example of a print output and distribution system according to some aspects of the invention; and,

FIG. 21 shows an example of an automated picture-in-postcard overlay function according to some aspects of the invention.

### A DETAILED DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Some aspects of the invention relate to an interactive sign system having a back-lit physical display or “static” portion and an electronic or “dynamic” portion. The static and dynamic portions of the system may display similarly-themed content to a user. The content may relate to a specific business, tourist attraction, event, promotion, or the like. The user may use the system to send a message to one or more recipients. The one or more recipient receives content similar to that displayed to the user along with the user's message.

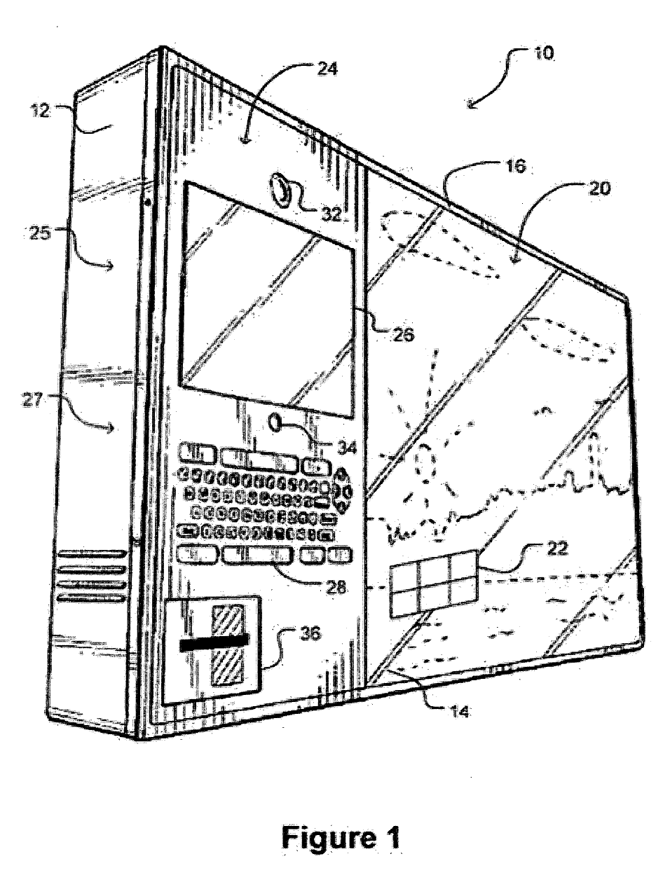

FIG. 1 shows an interactive electronic display (also referred to as a “kiosk”) 10 according to one aspect of the invention. Kiosk 10 combines an illuminated sign portion 20 and a computer controlled display 25. Kiosk 10 includes a user interface 27 which permits a user to interact with an application provided by way of kiosk 10. The application could, for example, include one or more of:
an application for creating and sending electronic postcards;
an application for providing feedback regarding movies or other events and delivering that feedback to others;
an application for providing information about activities, events, physical locations or the like in the vicinity of kiosk 10; and, the like.

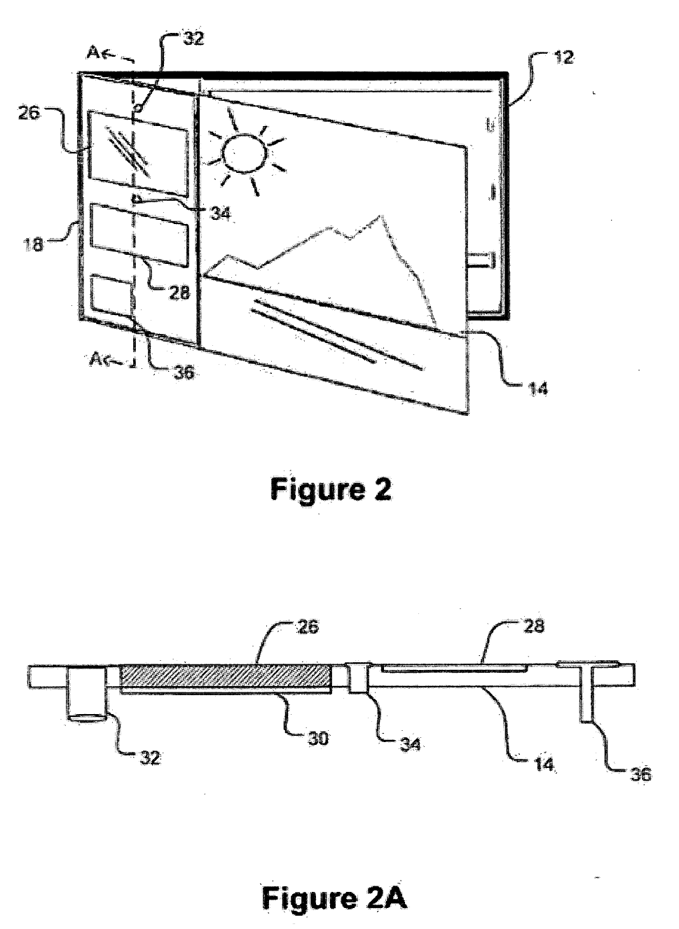

Although the invention, in its broad sense, is not limited to specific details of construction, the attached FIGS. 1 to 4 and 10 show kiosks 10 according to specific embodiments of the invention. Some of these details of construction are considered to be inventive. In these Figures, kiosk 10 comprises a shell 12 to which a front panel 14 is attached. A one piece frame 16 is fitted around panel 14 at the intersection of panel 14 and shell 12. Panel 14 is preferably a single piece and attached to shell 12 by means of a hinge 18, as can be seen in FIG. 2 which depicts kiosk 10 with frame 16 removed and panel 14 partially open. Panel 14 may be constructed, for example, from a single sheet of Lexan™ or other suitable plastic.

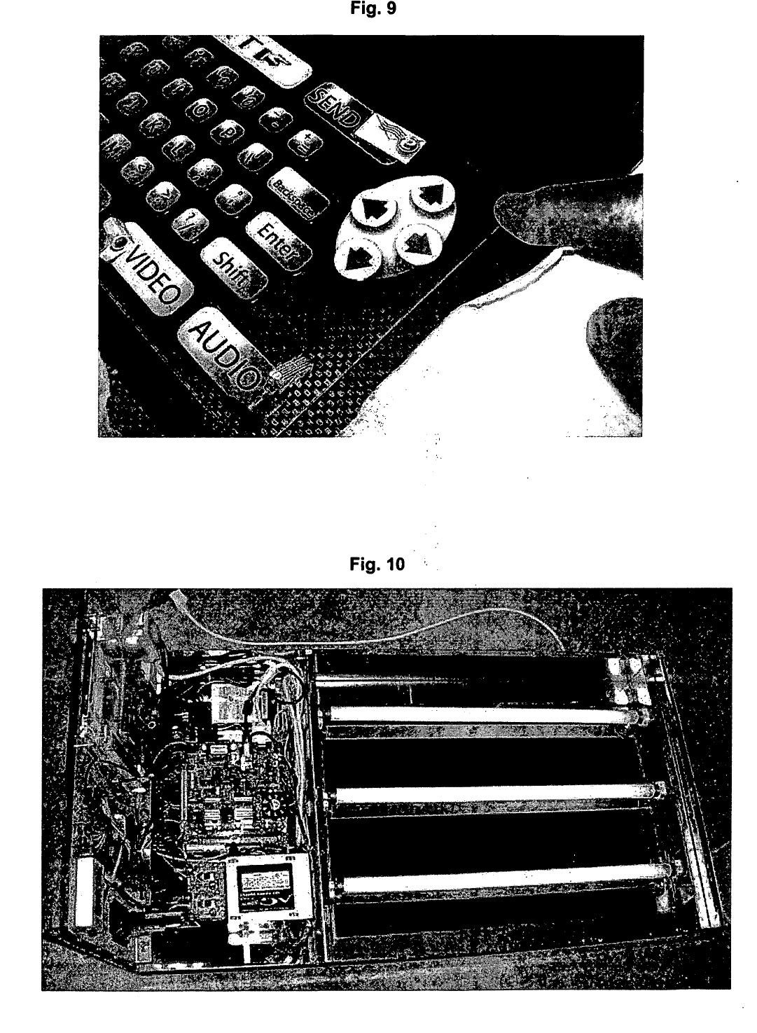

Panel 14 comprises a physical display portion 20 with indicia 22 thereon for identifying products which a user may purchase from kiosk 10. Panel 14 also comprises an electronic display portion 24 with a transparent portion 26 and a membrane touch keyboard 28. Membrane touch keyboard 28 is integrally formed in the material from which panel 14 is constructed. The material may be routed to provide keys of keyboard 28. FIG. 9 is a photograph which shows an example of keyboard 28. In some alternative embodiments of the invention keyboard 28 is separate from but mounted flush with the surface of panel 14. For example, a thin membrane-type keyboard may be laid into a recess routed into the face of panel 14. Electronic display portion 24 of panel 14 has a screen 30 mounted to a backside thereof behind transparent portion 26, as shown in FIG. 2A. Electronic display portion 24 of panel 14 also has a camera 32, a microphone 34 and a card reader 36 mounted there through.

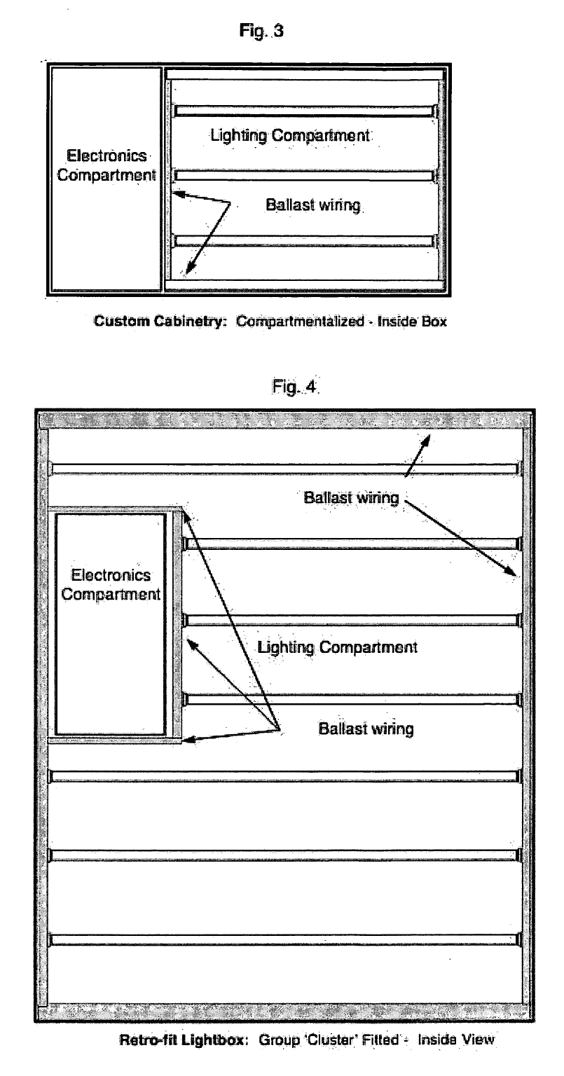

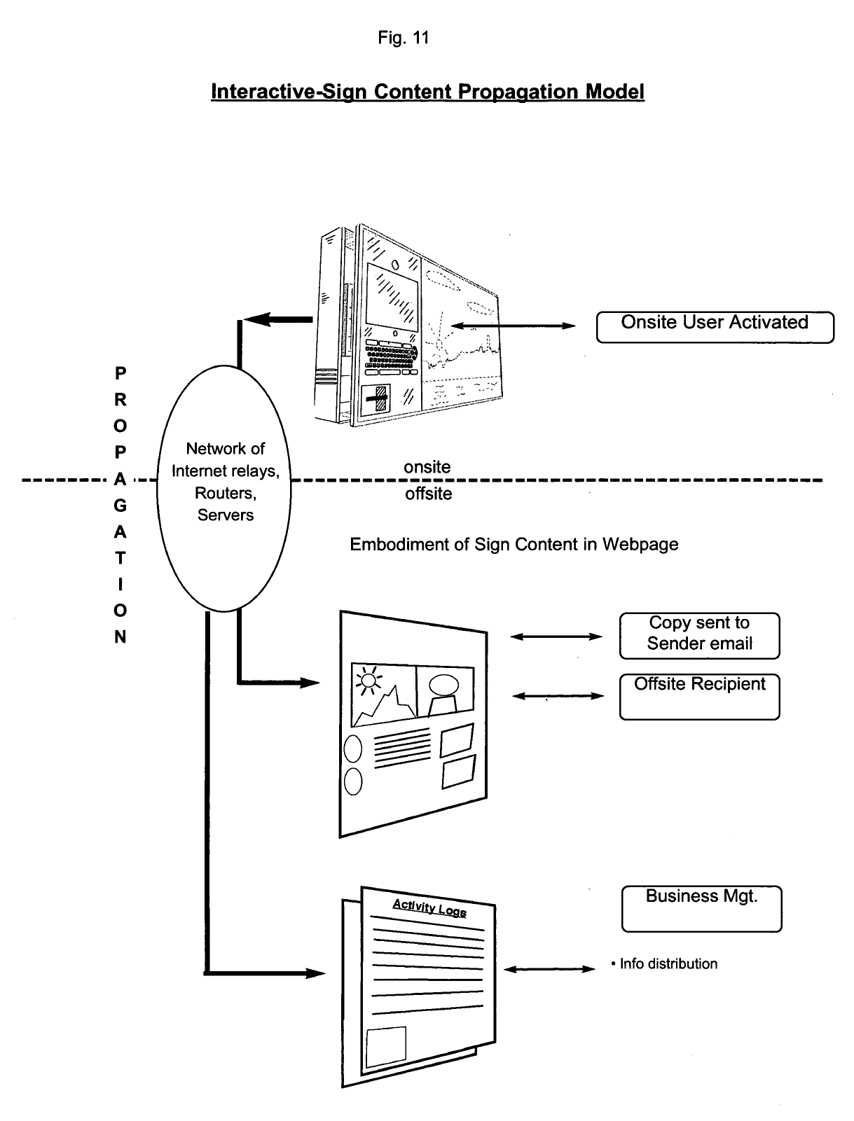

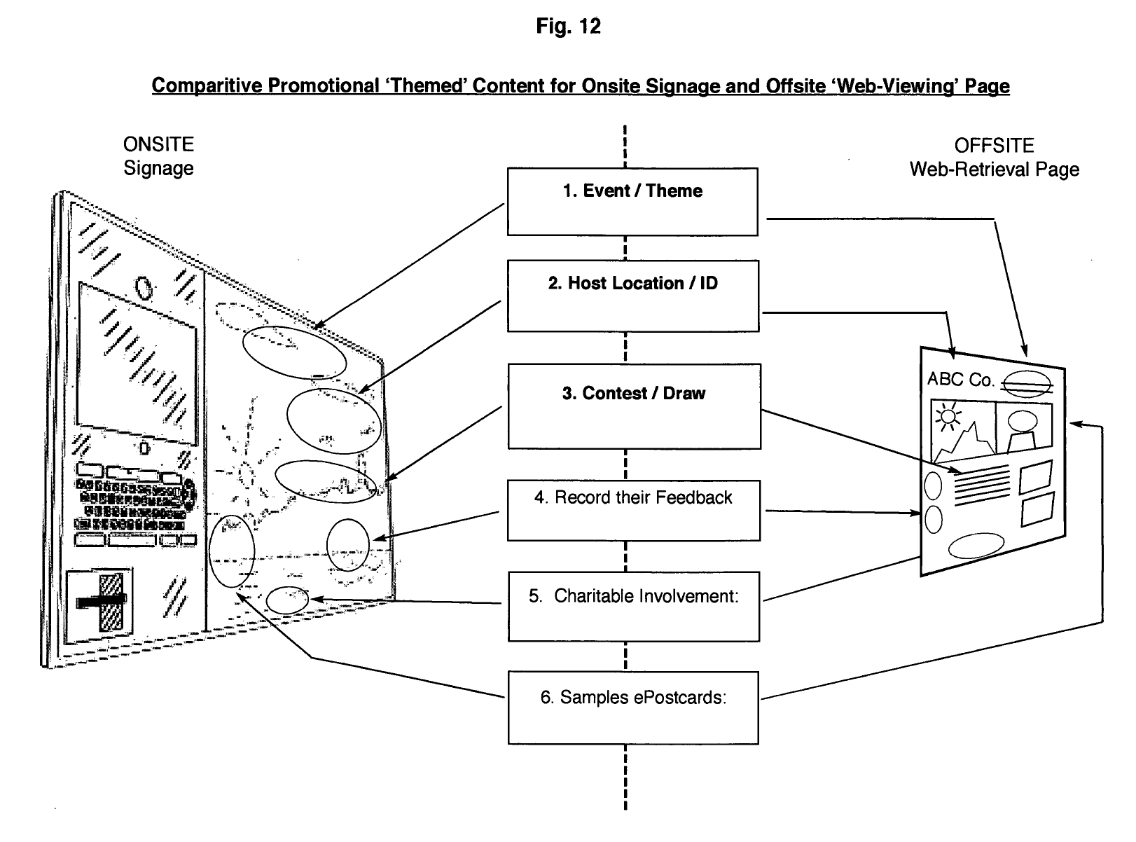

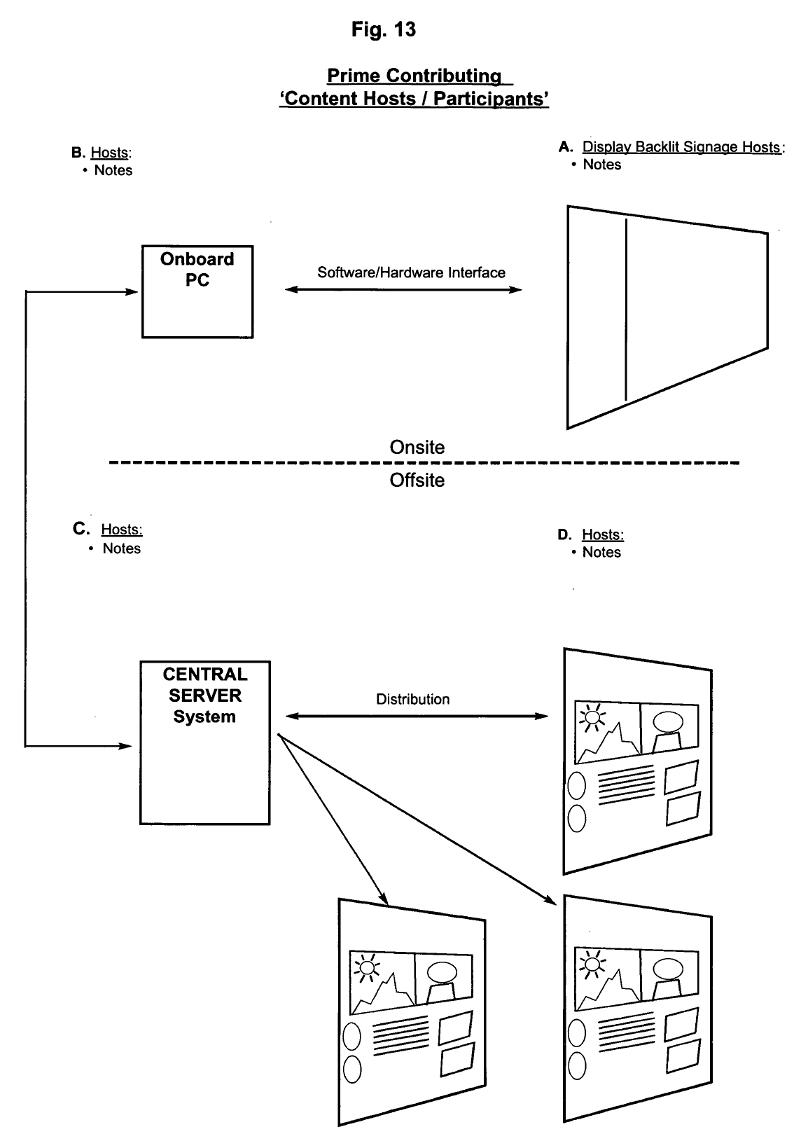

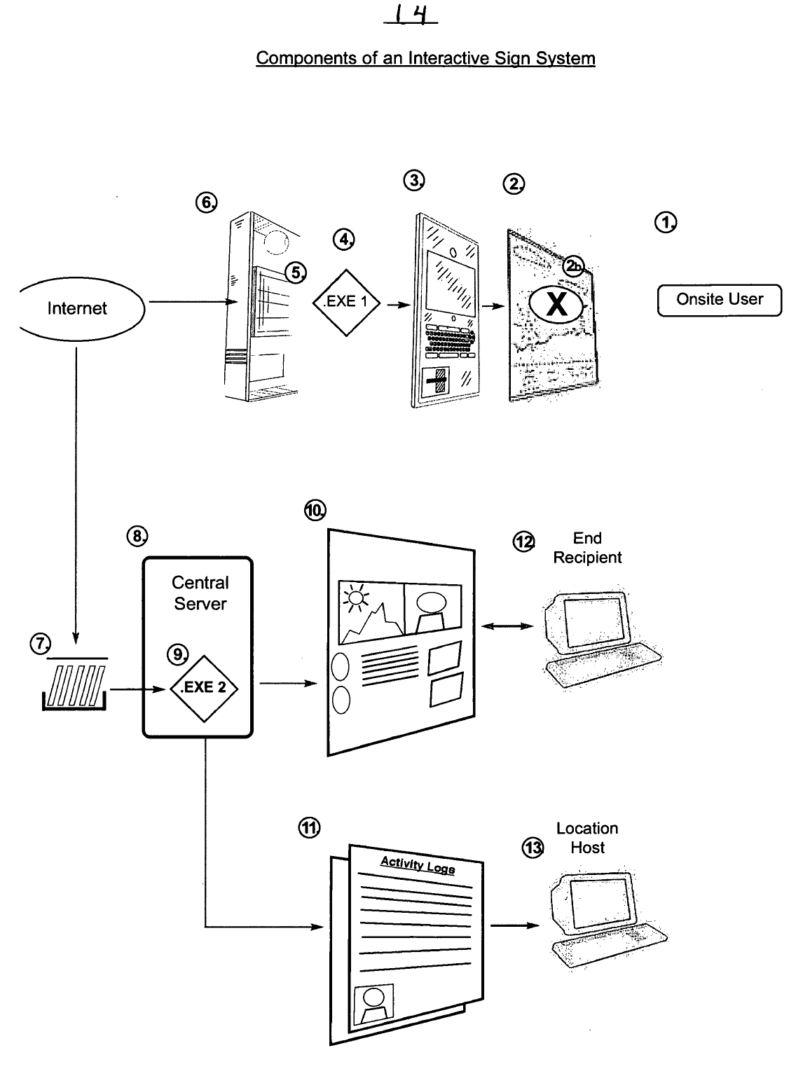

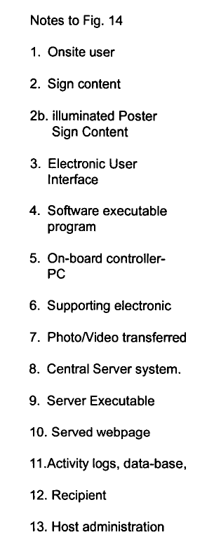

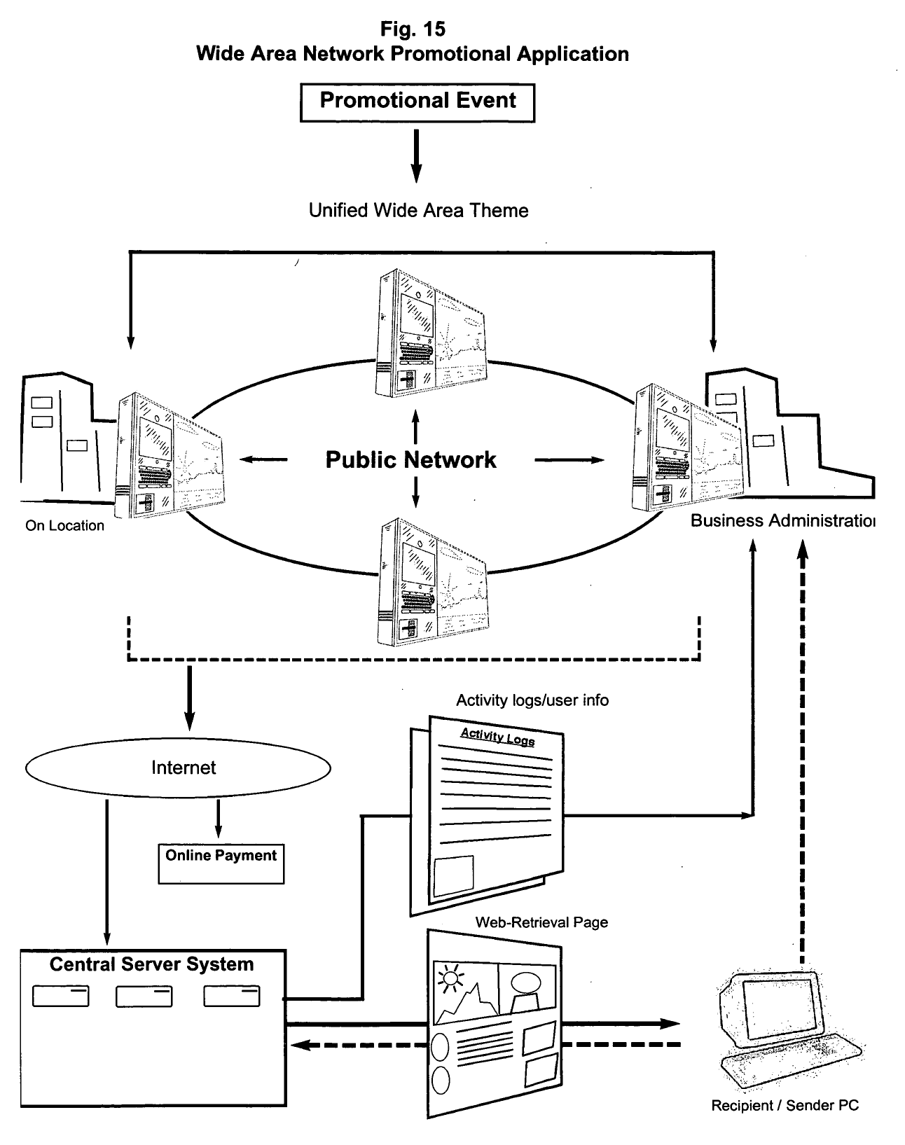

As best seen in FIG. 3, which depicts kiosk 10 with panel 14 removed, shell 12 houses an electronics compartment 38 and a lighting compartment 40, which are respectively-located behind electronic display portion 24 and physical display portion 20 of panel 14. Electronics compartment 38 comprises a processor and supporting electronics, an example of which can be seen in the photograph of FIG. 10. Lighting compartment 40 comprises conduits 42 for housing wiring and ballast (not shown). Brackets 44 are attached to conduits 42 for supporting lights 46. As shown in FIG. 4 a combination of longer and shorter lights 46 may be used to illuminate all portions of panel 14 except for those portions in front of electronics compartment 38. Conduits 42 and brackets 44 are modified to help accommodate wiring for the contents of electronics compartment 38.

A transparency (not shown in FIG. 3) is located in front of lights 46. The transparency may bear images or other indicia displayed to the user in physical display portion 20 with a common theme of the content displayed by computer controlled display 25. As one skilled in the art will appreciate, kiosk 10 may have a size and/or shape different from those shown. FIG. 4 illustrates an example of a kiosk 10 that is larger than the example depicted in FIGS. 1 to 3. In the FIG. 4 example, modified conduits 42′ are provided around the edge of electronics compartment 38.

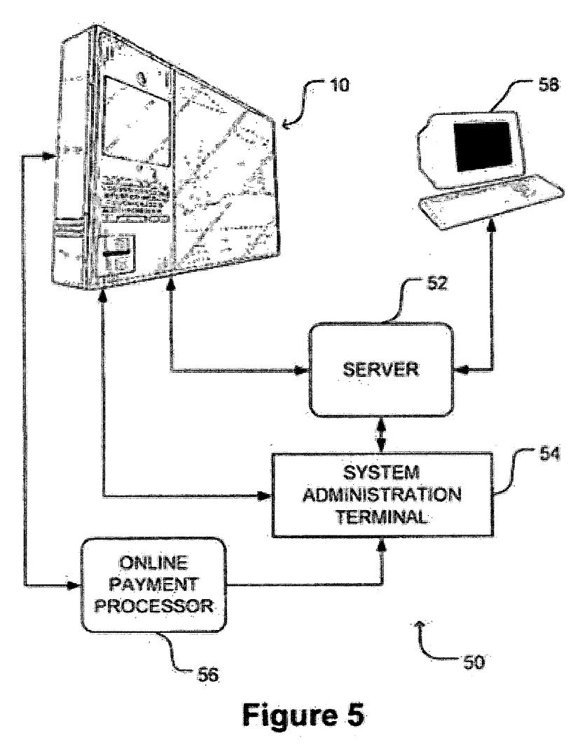

FIG. 5 illustrates schematically a system 50 according to one aspect of the invention. System 50 comprises a server 52 electronically connected to one or more kiosks 10 (although only one kiosk 10 is shown in the FIG. 5 example). Server 52 and kiosks 10 are also electronically connected to a system administration terminal 54. Kiosks 10 are also electronically connected to one or more online payment processors 56, in order to obtain real time payment authorization. Online payment processors 56 are also preferably electronically connected to system administration terminal 54 to provide payment information about purchases made at kiosks 10. Server 52 is configured to deliver coded links to one or more recipient terminals 58, such that a recipient can access content on server 52, as described below. The electronic connections in system 50 may comprise a wireless network, a local area network, the internet, or the like, and may be accomplished by any suitable wireless or wired modalities.

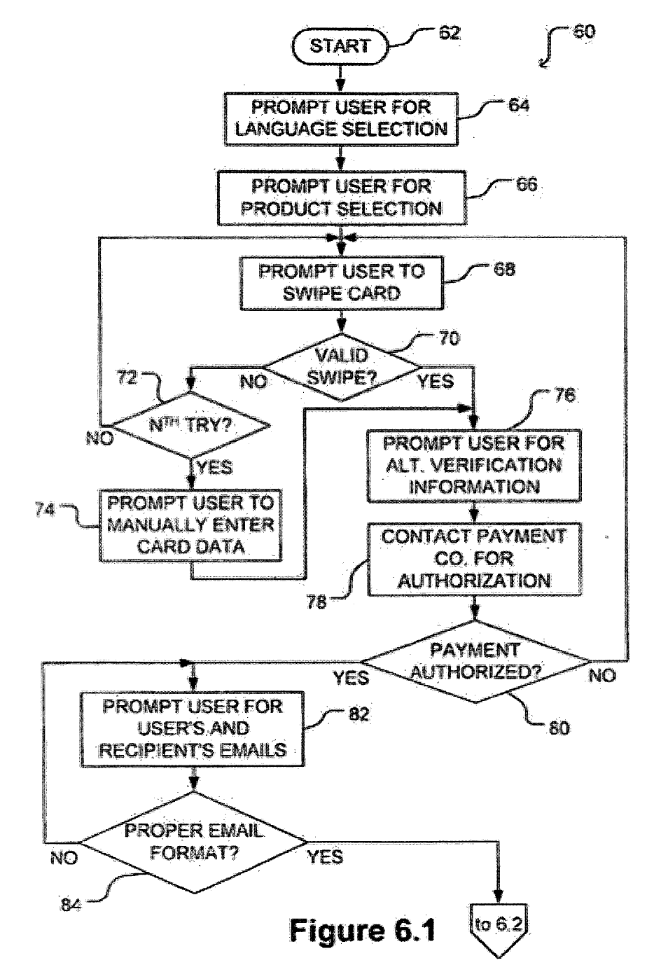

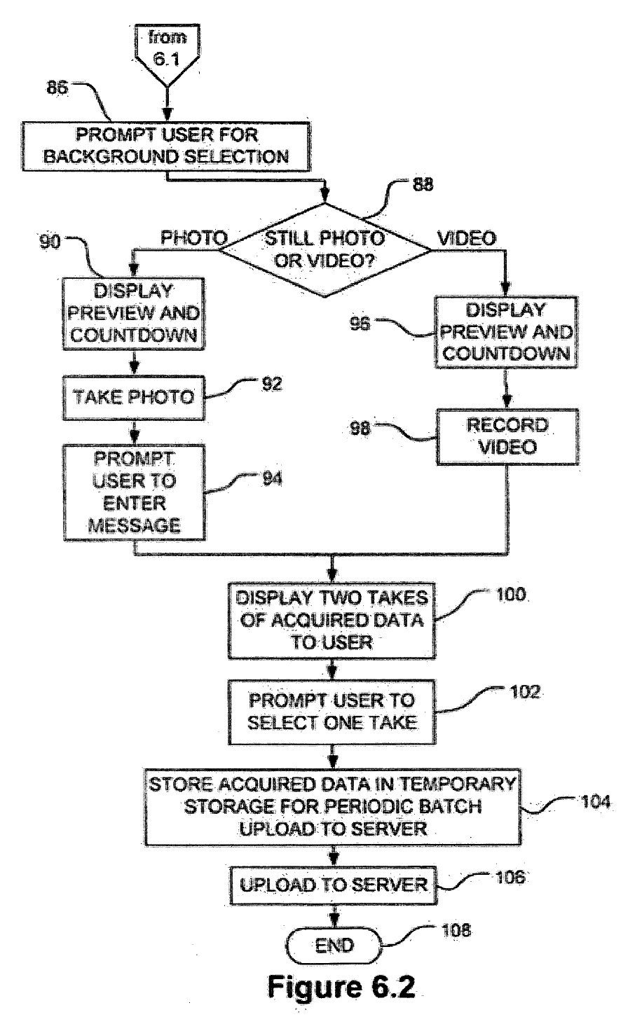

FIGS. 6.1 and 6.2 show a method 60 carried out by the electronics of a kiosk 10 according to one aspect of the invention. Kiosk 10 remains in a standby state, wherein a screensaver is displayed on screen 30, until triggered to enter an active state by a user. The screensaver may be selected by the system administrator or the operator of the business (also referred to as the “host”) where kiosk 10 is located, and may include advertising information. The screensaver may display images related to the images shown on physical display portion 20. Kiosk 10 may be configured to enter the active state when any key on keyboard 28 is pressed by a user. Alternatively, kiosk 10 may be provided with a motion sensor (not shown) and configured to enter the active state when a user approaches kiosk 10. Method 60 begins at block 62, where kiosk 10 enters the active state and causes screen 30 to display an animated “tour guide” which will guide the user through method 60.

At block 64, the tour guide prompts the user to select a language. The user's choice of language determines the language in which the rest of the user's interactions with kiosk 10 are carried out. At block 66 the user is prompted to select a product to purchase from kiosk 10 In the illustrated example, the user may choose to send an electronic postcard or video message to one or more recipients. Other examples of products which could be purchased from kiosk 10 include physical items displaying the user's picture (which would be printed on the items at a remote location and shipped to the recipient's mailing address), such as paper postcards, t-shirts, mugs, etc.

Once the user has selected a product, the tour guide prompts the user to pay for the product. This may be accomplished, for example, by the user swiping a payment card (such as a debit card or credit card) in card reader 36 at block 68. At block 70, kiosk 10 determines if the card's information was properly read by card reader 36. If not (block 70 NO output), kiosk 10 determines if the user has already swiped their card a predetermined number of times (e.g., more than two times), in which case (block 72 YES output) the tour guide prompts the user to manually enter their card's information using keyboard 28 at block 74. If the user has not already swiped their card the predetermined number of times (block 72 NO output), the tour guide prompts the user to swipe their card again (block 68).

Once the user's card's information has been read by card reader 36 or manually entered by the user, the tour guide prompts the user to enter alternative verification information (e.g., postal code, PIN, etc.) at block 76. Kiosk 10 then proceeds to electronically contact a specific payment processor 56 associated with the user's card at block 78 to request live authorization for the purchase price of the product selected by the user. The user's card information is conveyed to payment processor 56 by means of a secured encrypted communication (e.g., PGP standard). At block 80 kiosk 10 receives feedback from payment processor 56, again by means of a secured encrypted communication (e.g., PGP standard). If the payment is not authorized (block 80 NO output), the tour guide indicates the lack of authorization to the user and the method returns to block 68 where the tour guide prompts the user to swipe a different card.

Once the payment has been authorized (block 80 YES output) the tour guide prompts the user to enter the user's email address and the email address of the recipient(s) at block 82. (If the user has selected a physical item to be delivered to a recipient, the tour guide prompts the user for the recipient's mailing address. If the user does not know the recipient's mailing address, the user may be provided with the option of looking it up in an online directory, or submitting the address by email at a later date.) At block 84 kiosk 10 checks to see if the email addresses entered by the user have the proper format. If not (block 84 NO output), method 60 returns to block 82 and the tour guide prompts the user to enter the email address(es) again, and explains the proper format to the user.

Once the user has entered the email addresses in the proper format (block 84 YES output), the tour guide prompts the user to select a background at block 86. The backgrounds available for selection are indicated by indicia 22 on panel 14. The available backgrounds may be specifically related to the location of kiosk 10, and may be update remotely by the system administrator without touching kiosk 10, for example by means of system administration terminal 54. The available backgrounds may be enabled by the architecture of the program/folder structure. The user may select a background by using arrow keys on keyboard 28. At block 88 method 60 determines which product the user selected at block 66. In the illustrated example, the available products are electronic still-photo postcards and video postcards.

If a still-photo postcard was selected (block 88 PHOTO output), screen 30 displays a preview of the image to be captured by camera 32 and a countdown to the time for taking the photograph at block 90. At block 92 camera 32 takes a photograph of the user. The tour guide then informs the user that they may now do a second “take” of the photograph, and method 60 repeats blocks 90 and 92. At block 94 the tour guide prompts the user to enter a text message for the postcard. Once the user has entered the text message method 60 proceeds to block 100.

If a video postcard was selected (block 88 VIDEO output), screen 30 displays a preview of the image to be captured by camera 32 and a countdown to the time for taking a video message at block 96. At block 98 camera 32 and microphone 34 record a video message from the user. The tour guide then informs the user that they may now do a second “take” of the video message, and method 60 repeats blocks 96 and 98. Once two takes of the video message have been recorded method 60 proceeds to block 100, as described below.

At block 100, screen 30 displays the two takes of the acquired data (either the photograph superimposed on the background selected by the user alongside the text message, or the background selected by the user alongside the video message) to the user. At block 102 the tour guide prompts the user to select one take of the acquired data. After the user has selected one of the takes of acquired data, method 60 proceeds to block 104 and the selected acquired data is stored in temporary memory in kiosk 10 until it is batch uploaded to server 52 at block 106. Method 60 then ends at block 108 and kiosk 10 returns to the standby state. If server 52 is not available to accept a batch upload, kiosk 10 may return to the standby state and be ready for another user before the acquired data is uploaded to server 52.

Raw video messages are typically captured by kiosk 10 in .AVI format and converted to .WMV format before being uploaded to server 52. Digital video captured in .AVI format at 30/frames per second can be jerky if played over the internet in streaming format. A compression encoding may be applied to optimize video playback without interruption or lag. This encoding is achieved through various settings and adjustments of frame rate and compression formats. Once achieved, video messages can playback properly. Server 52 uses the compressed, encoded, video file for playback to the recipient(s) upon receipt of a retrieval request or an incoming access link, as described below.

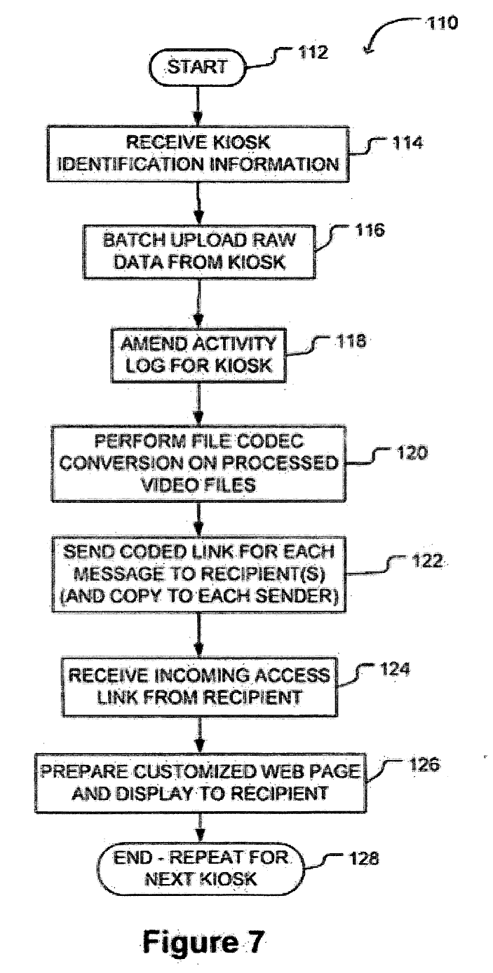

FIG. 7 shows a method 110 carried out on server 52 according to one aspect of the invention. Method 110 is carried out periodically for each kiosk 10 associated with server 52. For example, method 110 may be carried out approximately every 20 minutes for each kiosk 10. Method 110 begins at block 112 where server 52 establishes an electronic connection with a kiosk 10. At block 114 server 52 receives kiosk identification information from kiosk 10. At block 116 server 52 batch uploads any raw data from kiosk 10 which is stored in temporary electronic storage, which may comprise a local hard drive of kiosk 10. The raw data comprises the acquired data for all messages stored in the temporary storage of kiosk 10 since the last time method 110 was carried out for that kiosk 10. If there is no raw data to upload method 110 proceeds directly to block 128 and terminates. Acquired data typically resides on kiosk 10 for up to 24 hours as a safety buffer for the data, or until confirmation of receipt of data by server 52. In the event of a down server, kiosk can then be redirected to backup server, in which event kiosk 10 can then redirect data to new server without interruption.

Once the raw data has been uploaded, server 52 amends the kiosk's activity log at block 118. At block 120 server 52 performs file codec conversion on processed video files contained in the raw data. At block 122, for each message contained in the raw data, server 52 sends out an email to each recipient containing a coded link, and may optionally copy the sender. Each message comprises the user selected background and either the photograph and text message or the video message. At block 124 server 52 receives an incoming access link from a recipient, which may be accomplished by the recipient clicking on the coded link. At block 126 server 52 prepares a customized web page for the message and displays it to the recipient who sent the incoming access link. The customized web page comprises the message as well as promotional material selected according to the host of kiosk 10 from which the raw data was uploaded. The promotional material may comprise, for example, advertising, special offers, requests for charity donations, or the like. Method 110 then proceeds to block 128 and terminates. After method 110 has terminated at block 128 server 52 may carry out method 110 again for a different kiosk 10.

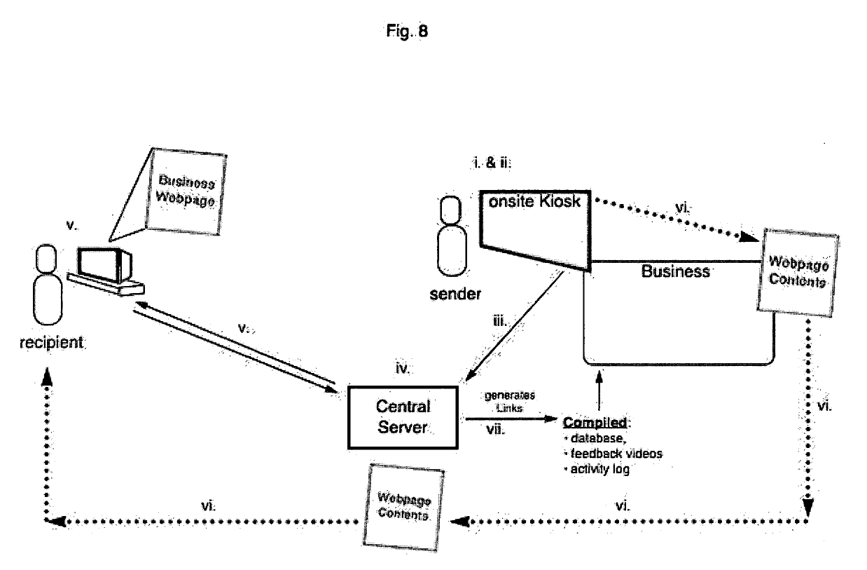

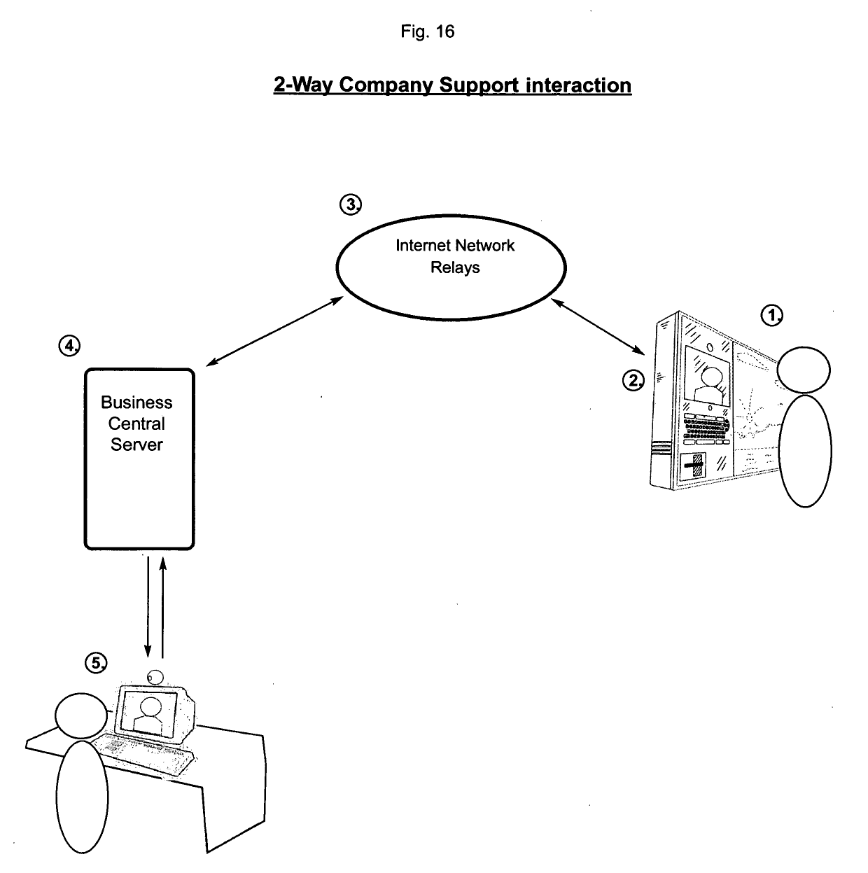

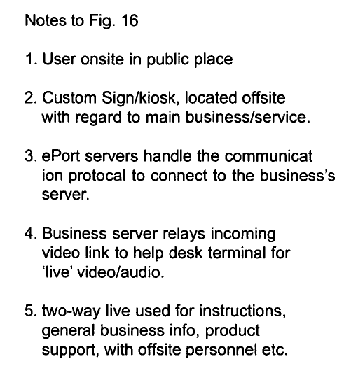

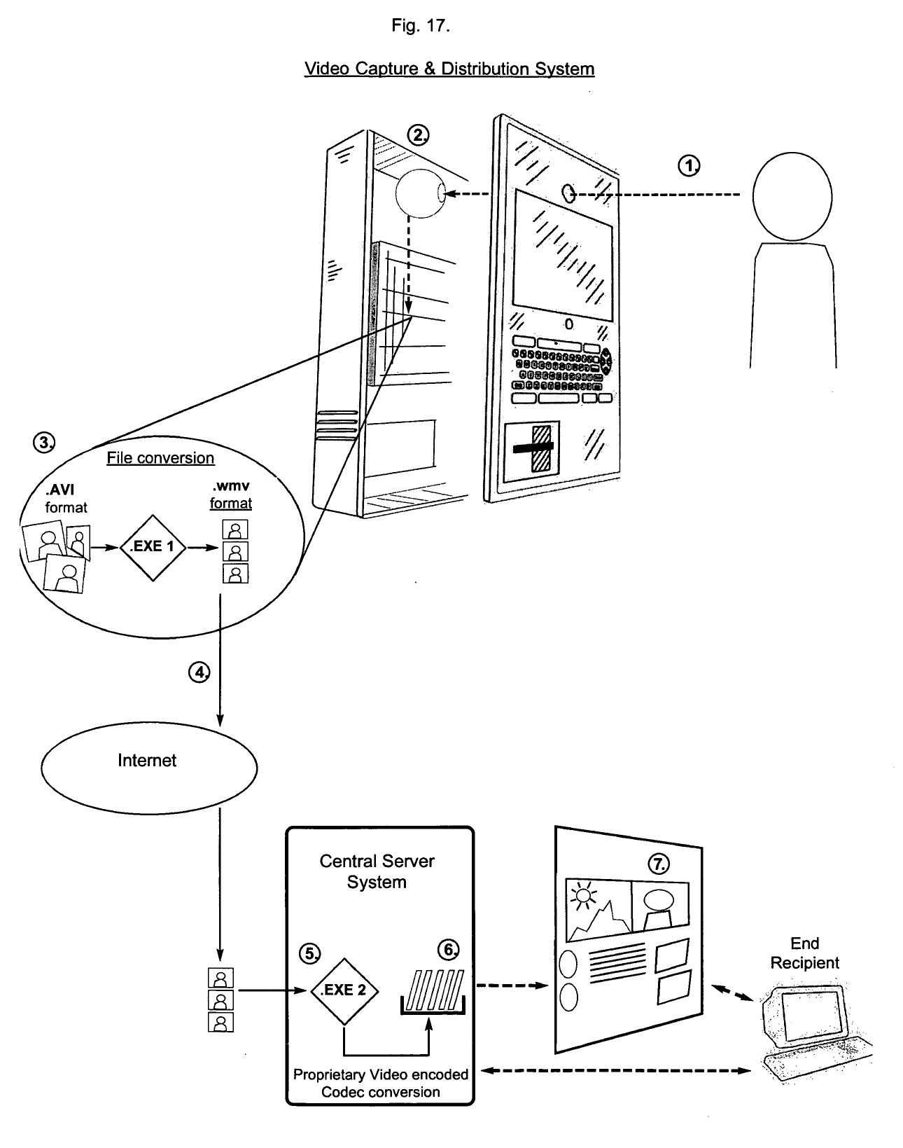

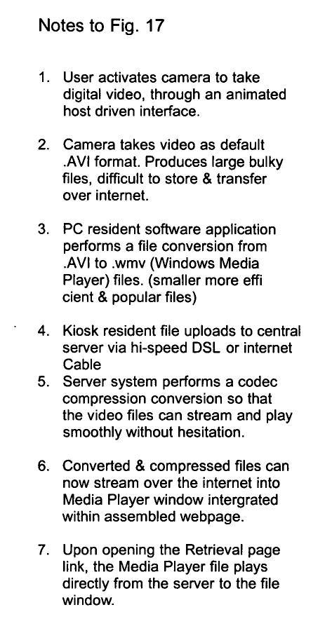

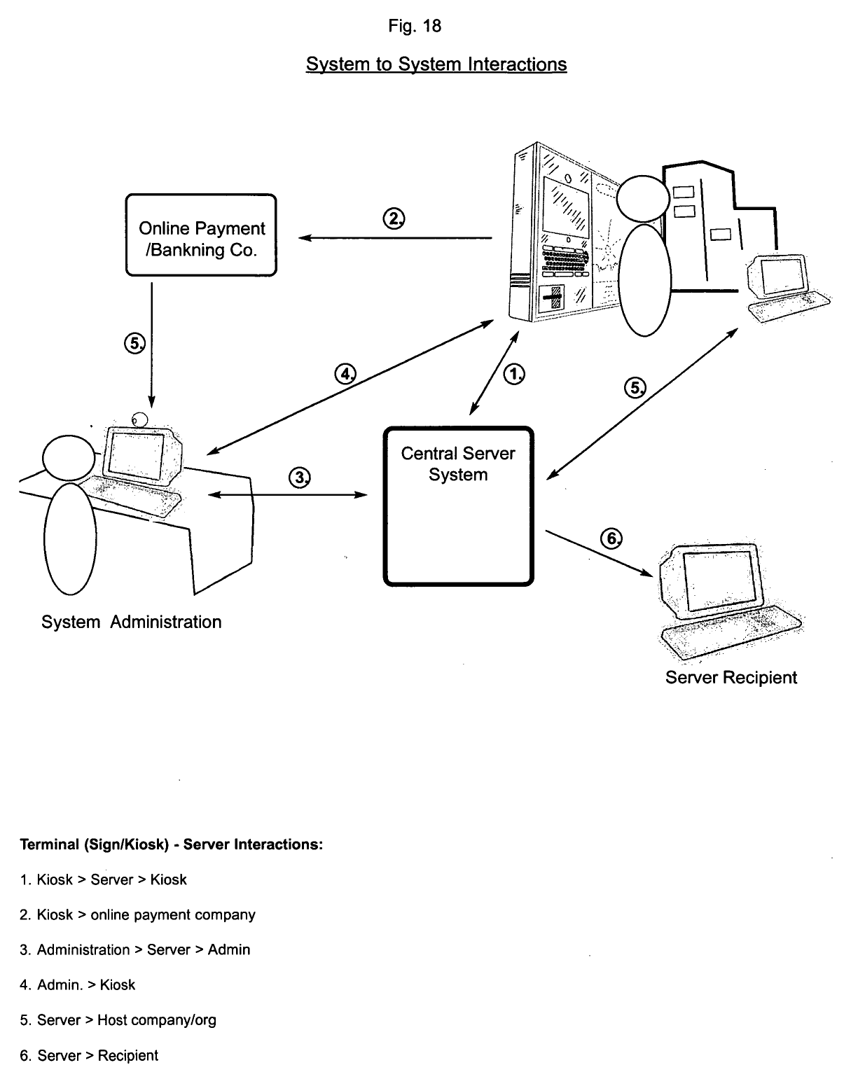

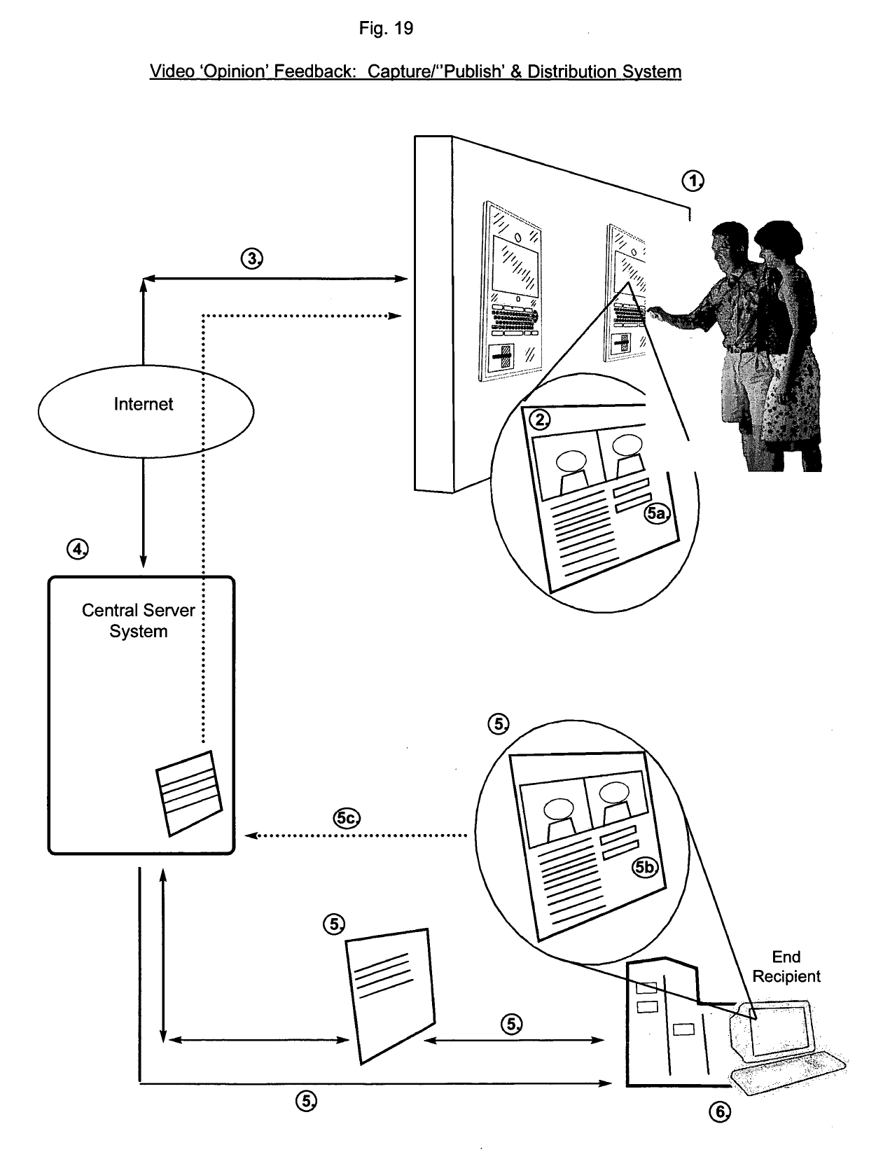

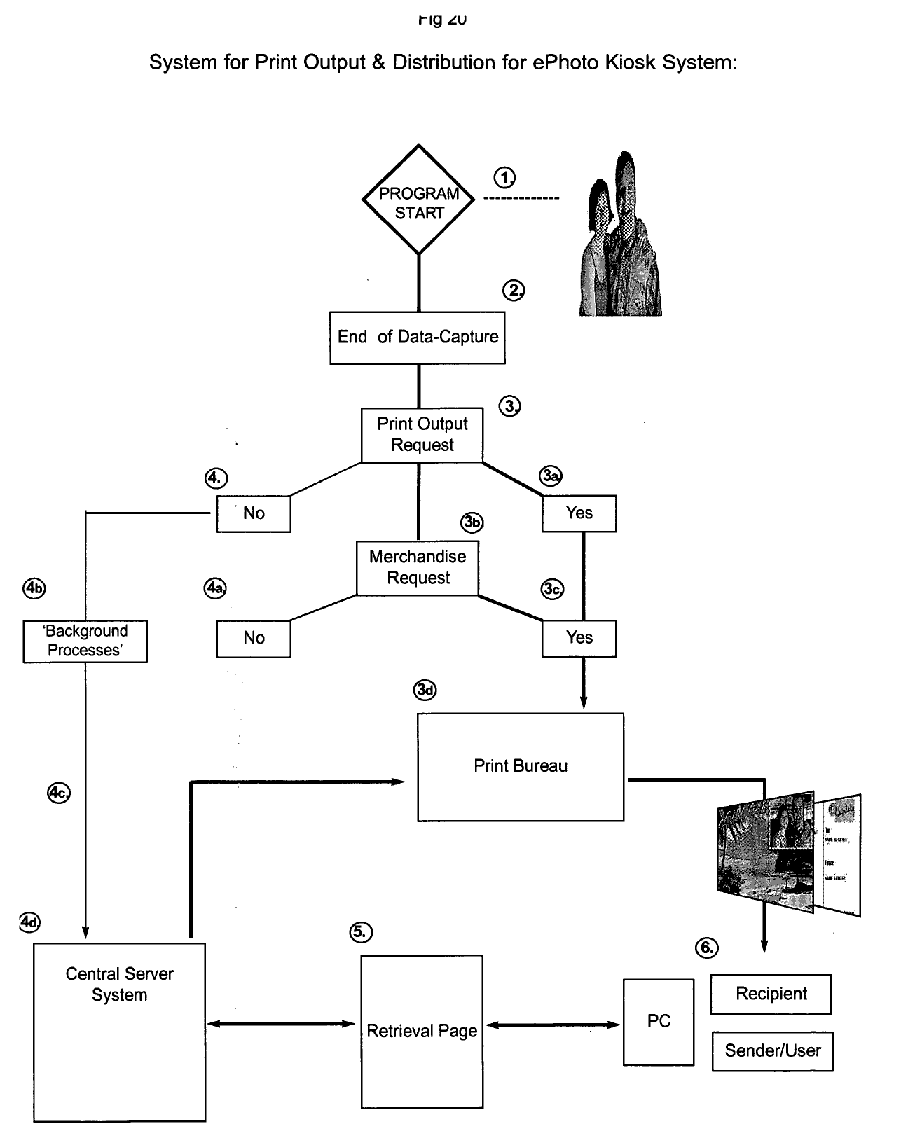

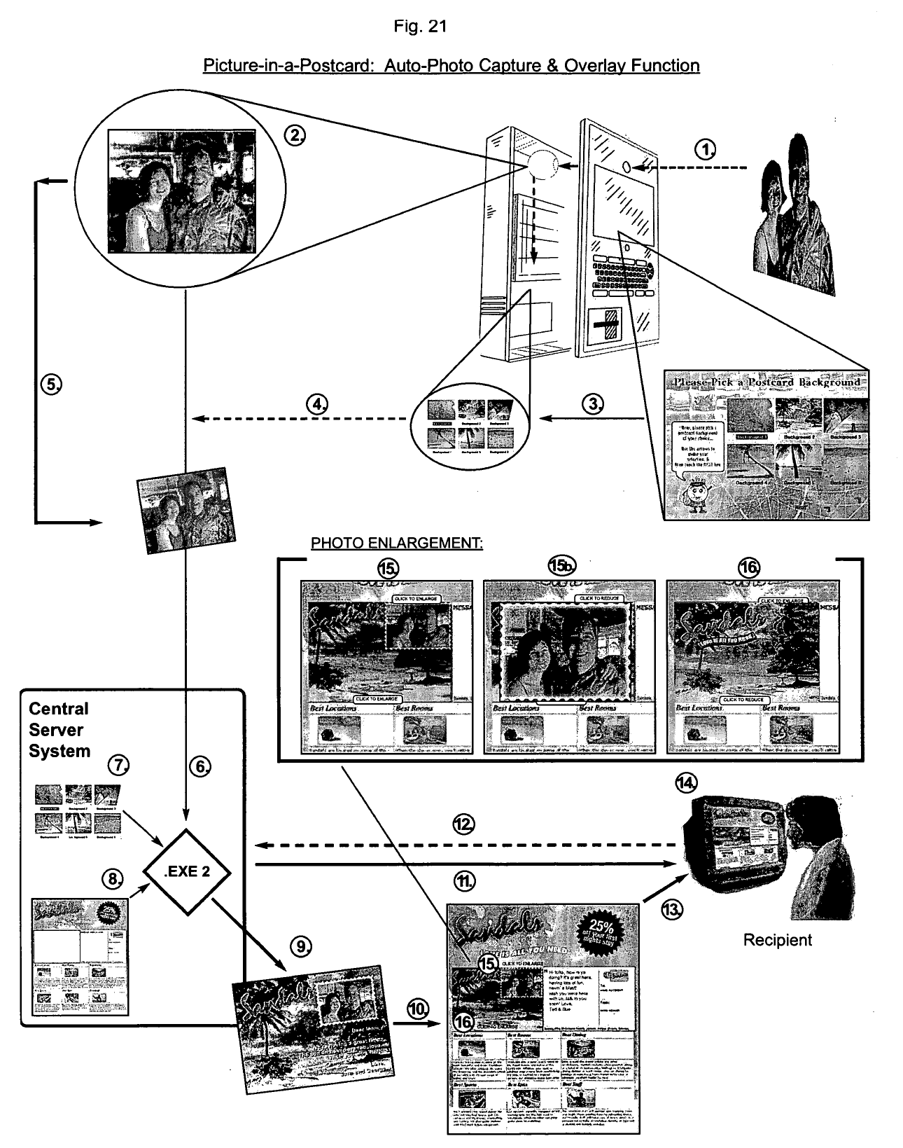

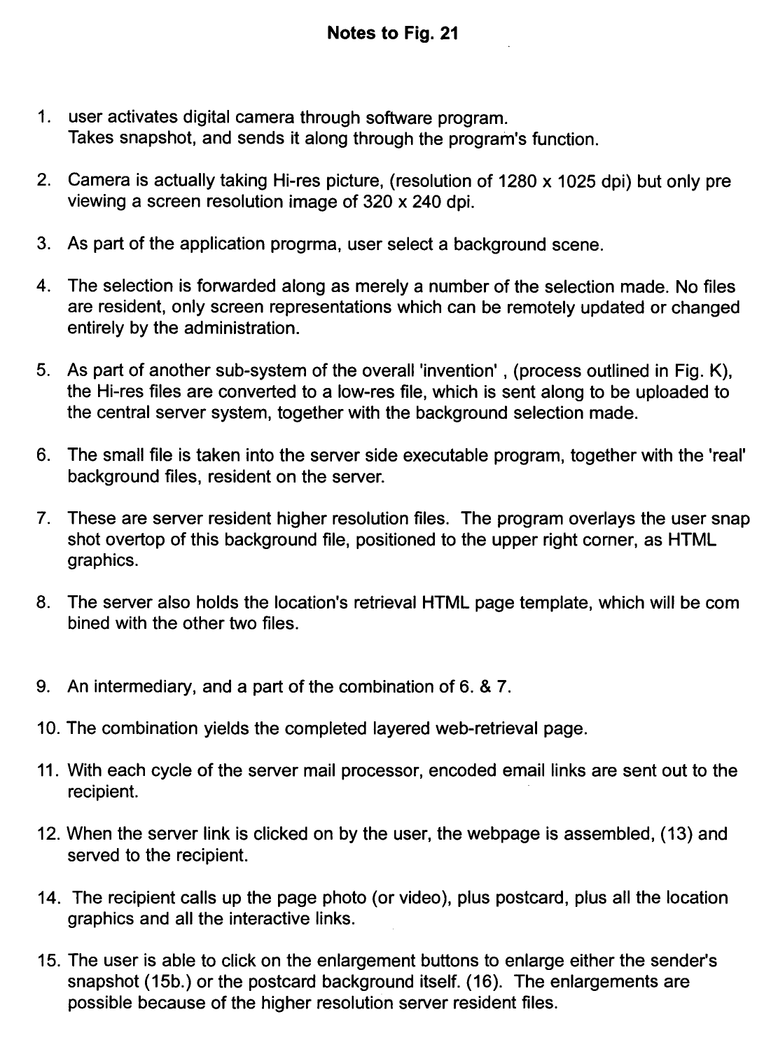

FIG. 8 schematically depicts the steps carried out in a marketing system 130 according to one aspect of the invention. In step i a kiosk 10 is installed on the business premises of the host. In step ii a user or “sender” records a message on kiosk 10. In step iii the message is uploaded to server 52. In step iv server 52 prepares a customized web page containing the message and promotional material selected by the host. In step v server 52 sends a coded link to the recipient, who clicks on the coded link at recipient terminal 58 to display the customized web page. In step vi the promotional material selected by the host of kiosk 10 is displayed to the recipient. In step vii server 52 compiles a database of all senders' and recipients' email addresses, as well as all recorded messages and an accounting spreadsheet of activity at the host's kiosk 10, and provides the database to the host. An example of interaction between a user and host is illustrated in FIG. 16. In some jurisdictions, privacy rules require that consent be obtained from the senders and recipients in order to collect their personal information. Such consent may be obtained from the senders when they are using kiosk 10 or by means of an email request at a later date. Consent may be obtained from the recipients when they click on the coded link, or by means of an email request at a later date. The email addresses and messages of senders and recipients who do not provide their consent may be omitted from the database.

As will be apparent to those skilled in the art in the light of the foregoing disclosure, many alterations and modifications are possible in the practice of this invention without departing from the spirit or scope thereof. For example, kiosk 10 may be located at a movie theater and display information about movies playing at the theater, and the user could use kiosk 10 to send their comments on a movie they have seen to their friends and family. The user pays to record opinions of movie, propagates their opinions to friends and family by means of an outgoing retrieval page which may include theatre/sponsors/event info/graphics, plus discount coupons for the recipient. Resource links may go out from server 52 to participating sponsors.

Also, a host may provide a kiosk 10 for the host's customers to record their comments about the host's business and send those comments to the user's friends and family, or use the user's comments for promotional purposes.

Also, kiosk 10 may be used to conduct opinion polls. Kiosk 10 may be located in a third party location, (e.g., a public place such as shopping mall). Users are enticed to record opinions on products or services, or any other topic, with the incentive of being paid for their time/opinion. In such an embodiment, card reader 36 now functions to credit payment onto the user's credit card or debit card, and server 52 sends the user a coded link for future participation for payment.

Also, kiosk 10 may be used for interactive advertising. Kiosk 10 may be located in a public location (e.g., a shopping mall, public milling area, etc.). Kiosk 10 may be a free standing unit placed to advertise products or services. Customers are enticed to participate, record feedback or sign up to belong to club/home email/newsletter by incentive of being paid to do so. Again, in such an embodiment, card reader 36 now functions to credit payment onto the customer's credit card or debit card.

What is claimed is:

1. An apparatus consisting of a processor, executable program, touchscreen, digital camera, microphone, and credit card reader, coupled with a lightbox display, residing in a singular enclosure as a user interactive ‘sign’, whereby certain executable functions can be carried out by users through an interface as presented on the touchscreen, based on the content theme of the lightbox.

2. the user of the apparatus in claim 1 is able to follow an easy to use on-screen set of navigation screens, aided by a video host-tour guide presenting them with instructional options in a variety of user selected multiple languages, whereby they are able to choose amongst options for service including an automated means of taking their photograph or recorded video, choosing one of a pre-programmed set of location photographs, including typing text messages on a screen represented keyboard, and keying in email addresses of known recipients for the purpose of a sending a customized e-photo or video-postcard.

3. As the payment for service offered by the program running on the apparatus in claim 1, the user will swipe a credit card through the card reader which makes a connection to a live online payment processor to process payment, whereby a real-time authorization is relayed back to the processor and running executable program in claim 2 to either allow the user to continue or prompts a retry or another card, and ultimately facilitating funds transferred to a specified recipient deposit account.

4. the apparatus in claim 1 is connected to the internet through a hi-speed connection, and in turn in connected to a central server running a separate executable program, which will be in ongoing communication and receiving uploaded data collected by the apparatus in claim 1, as input by the user through an executable program running on the processor in claim 1, whereby the data is sorted and accounted into an activity log.

5. the theme and content of the poster in the lightbox of the apparatus in claim 1 is mimicked in the form of a web-viewable HTML page design, and hosted on the server in claim 4, as a template bearing the sign content which would likely bear the content of the location on which the sign would be hosted, while allowing a blank placeholder ‘hole’ where the uploaded visual information captured through the apparatus in claim 1 will ultimately be featured.

6. the uploading of captured information through the apparatus in claim 1 is triggered by the completion of the executable program, and on a pre-timed cyclic basis, such as every hour, such that the processor may be freed up and not be occupied after completion of every user cycle, thereby allowing multiple service uses up until the hour cycling and uploading of captured data to the server in claim 4.

7. the receipt of the captured information outlined in claim 6. will be stored in dated storage files on the server in claim 4, and through the server executable will ultimately trigger the creation of an encoded link on a similarly running pre-timed schedule, such that this link will be sent out to the recipient email address specified by the user outlined in claim 2.

8. the recipient receives the encoded link in claim 7, that when clicked on, opens the template html page in claim 5 as served by the server in claim 4, which then results in the mail processing and automatic composition of a web-viewing page complete with the captured user information including text, photo, video and audio, plus any marketing advertising graphics and links that may be present as a result of the the direction of the location management, thereby propagating the content of the onsite sign to the offsite recipient as activated by a user function.

9. the program in claim 2 is allows the user to compose a customer e-postcard, starting with the capture of their photo or video and text into an a composited format, whereby the captured digital photo is automatically superimposed on top of the corner of a pre-selected background, and additionally optionally typed text is captured to a simile of the postcard backing in a heuristic fashion mimicking a real postcard, photo-customized on the front, and text messaged on the back, all of which is then embedded into the propagated page for the recipient to view in claim 8.

10. the system apparatus featured in claim 1 is also offered with a variation of user input as an option to the touch-screen featuring a touch membrane switch keypad, fixed and embedded flush-mount into the enclosure fascia, while the touch-screen features a programmable pop-up keyboard that appears and disappears as needed as per the running program.

11. the server in claim 4 which automates the preparation of an activity log tallies and updates the usage of users for the sign interactions on an hourly basis, and also compiles a database of both users and recipient email addresses that is forwarded along to the location holders, who may choose to include these email on their company mailing marketing lists, depending on whether or not the recipients have chosen to click on a link on the viewing page allowing consent for the location holder to include them in any future mailings.

12. the program running in claim 2 allows for the user to select in place or in addition to the emailing of a postcard to an email address, the printing and regular mailing of the postcard, whereby the photo and other information captured is sent by way of a third party offsite print bureau, where the user has included the physical address through the sign kiosk to the print bureau, thereby serving the functionality of an onsite order desk for an onsite digitally captured photo.

13. the system outlined in claims 1 and 2 is the basis of a marketing and advertising system as the location and other relevant sponsor information such as logos, links, graphics, offers are present on all screen, postcard and viewing page elements, including the onsite display signage itself.

14. the advertising in claim 13 also features the use of the the onboard touchscreen monitor as part of the apparatus in claim 1 for use as a promotional video opportunity when the system software program in claim 2 times out for non-usage and kicks into a screensaver mode featuring the video promotional material, which can be interrupted by the touching of the screen.

15. Additional methods of use of the apparatus in claim 1 and program in claim 2 include use in a fundraising application, whereby the poster lightbox features content of a charitable cause, and the onboard processor is running a variant program specialized in allowing a number of charitable theme related activities including on the spot donations, and the recording of supportive videos for the cause.

16. the method of claim 15 allows for credit card purchases to be placed through the apparatus credit card reader outlined in claim 1, for on the spot donations to the cause, and run through the same online processor in claim 3 for deposit to the charities deposit account.

17. the method in claim 15 will also make use of the apparatus in claim 1 and the program in claim 2, by allowing the user to peruse charity video clips on the onboard-LCD so as to become educated and aware of the needs of the cause, thereby creating a static and dynamic solicitation and donation unit.

18. A method of the apparatus in claim 1 and claim 2 also involve in similar manner to methods in claim 15, the solicitation of on the spot opinion gathering for any topic as displayed on the poster by a market research or other company, whereby the onboard LCD functions as in claim 17 to offer informative video clips, and entices the public to record opinions on the theme being displayed, and in addition, the option to vote various related issues as a numerical touch-based line item questionnaire can quickly and easily capture the votes.

19. A method for capture of live recorded opinions is outlined in claim 18 involves the user activated program as in claim 2, such that users can auto-record digital that will ultimately be uploaded to the server in claim 4, and distributed directly to the organization seeking to perform market research opinion and vote gathering.

20. A method for distribution and sharing of the captured opinions and votes in the system outlined in claim 19 is made possible by a special the server in claim 4 tabulating results and uploading to the main host company website for web-viewing access, whereby the means of a capture and publishing system is complete.
